(19) United States
(12) Patent Application Publication
(10) Pub. No.: US 2020/0026659 A1
(43) Pub. Date: Jan. 23, 2020

(54) VIRTUALIZED MEMORY PAGING USING RANDOM ACCESS PERSISTENT MEMORY DEVICES

(71) Applicant: NUTANIX, INC., SAN JOSE, CA (US)

(72) Inventors: Jan Ralf Alexander Olderdissen, Herrenberg (DE); Purushotham G. Lala Balaji, San Jose, CA (US)

(73) Assignee: NUTANIX, INC., SAN JOSE, CA (US)

(21) Appl. No.: 15/817,735

(22) Filed: Nov. 20, 2017

(51) Int. Cl. G06F 12/1009; G06F 12/1081; G06F 12/02; G06F 9/455

(52) U.S. Cl. CPC G06F 12/1009; G06F 9/45558; G06F 12/023; G06F 12/1081

(57) ABSTRACT

Systems for virtual memory computing systems. A set of hardware or software operational elements of a computing system performs virtualized memory paging. The operational elements serve to identify a random access memory device and at least one random access persistent memory device (RAPM) in a computing system. The random access persistent memory device is configured as a swap device that is apportioned as having at least some address space for swap. At least some of the swap address space is assigned to one or more virtualized entities in the computing system. When a page swap event is detected by the computing system, one or more of the operational elements execute one or more paging operations based on characteristics of the page swap event. The paging operations perform swap-in or swap-out of at least one page between the random access memory device and the random access persistent memory device.

### FIELD

This disclosure relates to virtual memory computing systems, and more particularly to techniques for virtualized memory paging using random access persistent memory devices.

### BACKGROUND

Paging or page swapping is a scheme used in computing systems to efficiently manage the limited physical memory space available to the operating system and processes of the computing system. Page swapping moves certain portions of memory contents (e.g., pages of data that are not immediately needed) from a higher performance physical memory device (e.g., a DDR4 DIMM) to a lower performance, but lower cost, secondary storage device or swap device (e.g., a hard disk drive or solid state drive). The space in the physical memory that is redeemed by the “page out” operation then becomes available for use by processes currently running in the operating system. Later, when a page of data on the secondary storage device is requested by a process, a page fault occurs which suspends the process so that the operating system can access the swap device to “page-in” the data of the page back in to the physical memory.

Such page swapping facilitates the formation of a virtual address space at the operating system, which virtual address space can greatly exceed the physical address space of the physical memory in the system. This allows the operating system to operate beyond the limits of the physical memory without crashing or rejecting tasks or processes that (individually or in aggregate) demand an address space that is larger than the random access physical memory of the system. In systems that implement virtual memory address translation, the operating system dynamically maps the virtual addresses to the physical addresses in a page table.

Unfortunately, executing page swaps between the physical memory device of a particular node and the hard disk drive (HDD) or solid state storage device (SSD) storage areas detrimentally impacts the performance of the computing processes and of the computing system as a whole. Specifically, while access latencies for data storage operations can be managed by queuing and/or buffering techniques implemented in the computing system, the access latencies associated with page swapping operations will directly impact the performance of the running processes (e.g., a process will necessarily be suspended while the page is being swapped back into physical memory). This performance impact is exacerbated on virtualized systems, where hundreds of virtualized operating systems and applications can compete for the same underlying swap device.

One legacy approach to addressing this negative impact is to disable all page swapping at the computing nodes. With this approach, however, the physical memory space allocated to each process is often oversubscribed to facilitate reliable and/or acceptable performance. For example, the amount of physical memory space allocated to a process might be set equal to the virtual memory space as demanded by the process. Since such high performance physical memory is often the dollar-wise costliest type of memory, this can be an expensive approach. What is needed is a technological solution for efficiently implementing page swapping in virtualized computing systems.

What is needed is a technique or techniques to improve over legacy techniques and/or over other considered approaches that address efficiently implementing page swapping in virtualized computing environments that have a high demand for physical memory resources. Some of the approaches described in this background section are approaches that could be pursued, but not necessarily approaches that have been previously conceived or pursued. Therefore, unless otherwise indicated, it should not be assumed that any of the approaches described in this section qualify as prior art merely by their inclusion in this section.

### SUMMARY

The present disclosure describes techniques used in systems, methods, and in computer program products for virtualized memory paging, which techniques advance the relevant technologies to address technological issues with legacy approaches. More specifically, the present disclosure describes techniques used in systems, methods, and in computer program products for memory page swapping between a random access memory (RAM) device and a random access persistent memory (RAPM) device. Certain embodiments are directed to technological solutions for implementing swap techniques in an operating system kernel and/or in a device driver to facilitate memory paging operations to and from a memory mapped storage device.

The disclosed embodiments modify and improve over legacy approaches. In particular, the herein-disclosed techniques provide technical solutions that address the technical problems attendant to efficiently implementing page swapping in virtualized computing environments that have a high demand for physical memory resources. Such technical solutions relate to improvements in computer functionality. Various applications of the herein-disclosed improvements in computer functionality serve to reduce the demand for computer memory, reduce the demand for computer processing power, reduce network bandwidth use, and reduce the demand for inter-component communication. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of memory subsystem architectures as well as advances in various technical fields related to operating system design and virtualization systems.

Further details of aspects, objectives, and advantages of the technological embodiments are described herein and in the drawings and claims.

### BRIEF DESCRIPTION OF THE DRAWINGS

The drawings described below are for illustration purposes only. The drawings are not intended to limit the scope of the present disclosure.

FIG. 1 illustrates a virtualized computing environment in which embodiments of the present disclosure can be implemented.

FIG. 2 depicts a virtualized memory paging technique as implemented in systems that facilitate memory page swapping between a RAM device and a random access persistent memory device, according to an embodiment.

FIG. 3 illustrates a distributed virtualization environment in which embodiments of the present disclosure can be implemented.

FIG. 4 presents a swap memory virtualization technique as implemented in systems that facilitate memory page swapping between a RAM device and a random access persistent memory device, according to an embodiment.

FIG. 5A depicts a block device emulation technique as implemented in systems that facilitate memory page swapping between a RAM device and a random access persistent memory device, according to an embodiment.

FIG. 5B illustrates a virtual I/O swap device access technique as implemented in systems that facilitate memory page swapping between a RAM device and a random access persistent memory device, according to an embodiment.

FIG. 5C presents a direct memory access paging technique as implemented in systems that facilitate memory page swapping between a RAM device and a random access persistent memory device, according to an embodiment.

FIG. 5D depicts a swap device data access technique as implemented in systems that facilitate memory page swapping between a RAM device and a random access persistent memory device, according to an embodiment.

FIG. 6 depicts system components as arrangements of computing modules that are interconnected so as to implement certain of the herein-disclosed embodiments.

FIG. 7A, FIG. 7B, and FIG. 7C depict virtualized controller architectures comprising collections of interconnected components suitable for implementing embodiments of the present disclosure and/or for use in the herein-described environments.

### DETAILED DESCRIPTION

Embodiments in accordance with the present disclosure address the problem of efficiently implementing page swapping in virtualized computing environments that have a high demand for physical memory resources. Some embodiments are directed to approaches for implementing swap techniques in an operating system kernel and/or in a device driver to facilitate memory paging operations to and from a memory mapped storage device. The accompanying figures and discussions herein present example environments, systems, methods, and computer program products for memory page swapping between a random access volatile memory device and a random access persistent memory device.

### Overview

Disclosed herein are techniques for implementing a virtualized swap framework to facilitate virtualized memory paging from random access memory (RAM) devices to random access persistent memory (RAPM) devices in a virtualized computing environment. In certain embodiments, one or more RAPM devices or segments of RAPM devices are configured as a swap device. The swap device is apportioned into swap space portions that are assigned to respective virtualized entities (VEs) running in the virtualized computing environment. Block-addressable requests are received from the VEs to perform certain paging operations. For example, a block-addressable request might be issued from the guest operating system of a particular VE operating on a computing node to request that a certain page of data at a RAM device of the computing node be swapped to or from a logical block address associated with the swap device. The block-addressable requests are transformed into byte-addressable instructions to issue to the swap device (e.g., RAPM device). The byte-addressable instructions are executed over the swap device to carry out the paging operations.

In certain embodiments, the virtualized swap framework facilitates issuance of swap requests from the VEs directly to the swap device. In certain embodiments, the virtualized swap framework facilitates direct memory access transfers of data pages to or from the swap device (e.g., RAPM device). In certain embodiments, swap requests are invoked in response to certain page swap events (e.g., a page fault). In certain embodiments, the data in the swap device (e.g., RAPM device) is accessed directly to facilitate execution of computer program instructions. In certain embodiments, the virtualized swap framework and/or other subsystems (e.g., operating systems, device drivers, etc.) of the computing node determine when pages are copied from the swap device (e.g., RAPM device) back into the RAM device. In certain embodiments, an intra-node block-addressable device is configured as a swap device.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

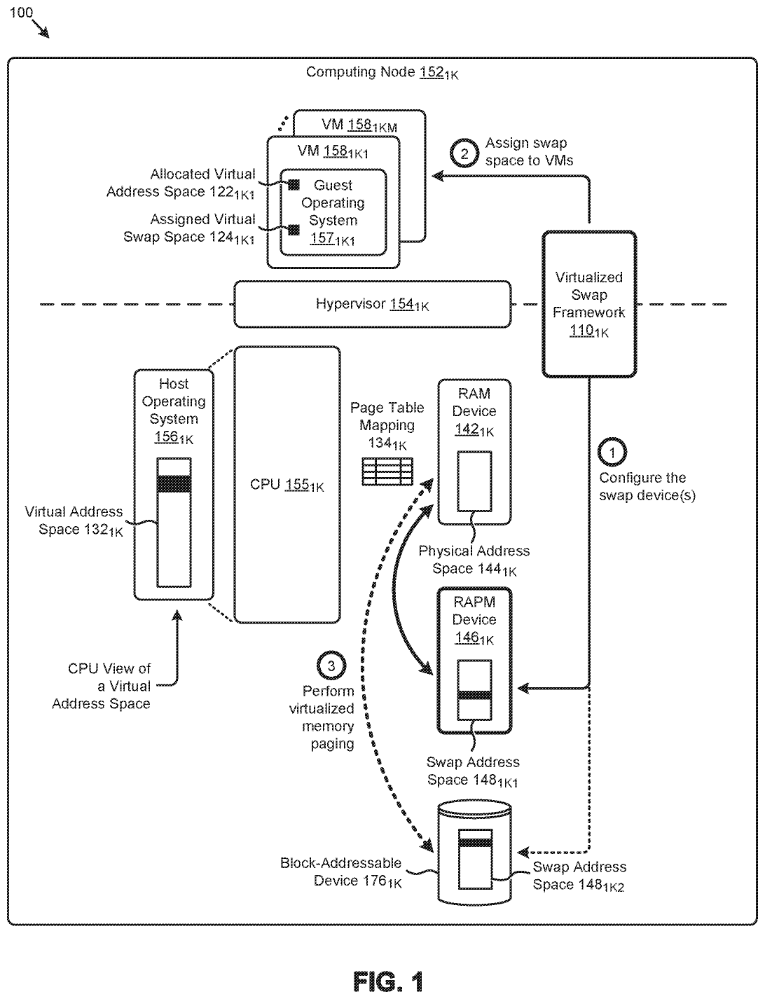

FIG. 1 illustrates a virtualized computing environment 100 in which embodiments of the present disclosure can be implemented. As an option, one or more variations of the virtualized computing environment 100 or any aspect thereof may be implemented in the context of the architecture and functionality of the embodiments described herein.

FIG. 1 depicts a computing node 152_{1K} that comprises a host operating system 156_{1K} operating on a CPU 155_{1K}. The host operating system 156_{1K} has access to a certain random access memory capacity provided by a RAM device 142_{1K} (e.g., a 256 GB DDR4 DIMM). Such access is facilitated by a page table mapping 134_{1K} that maps addresses of a virtual address space 132_{1K} of host operating system 156_{1K} to addresses of a physical address space 144_{1K} at RAM device 142_{1K}. In most cases, virtual address space 132_{1K} vastly exceeds physical address space 144_{1K}.

In the virtualized computing environment 100, CPU 155_{1K} and RAM device 142_{1K} of computing node 152_{1K} are “virtualized” by a hypervisor 154_{1K} so as to facilitate sharing of the CPU resource, RAM resource, and/or other resources by two or more virtualized entities (e.g., VM 158_{1K1}, . . . , VM 158_{1KM}). As an example, when VM 158_{1K1} is created, a portion of virtual address space 132_{1K} (e.g., allocated virtual address space 122_{1K1}) is allocated to the VM in accordance with a specified virtual memory size (e.g., 2 GB). The mapping of allocated virtual address space 122_{1K1} to virtual address space 132_{1K} and in turn to physical address space 144_{1K} is handled by various virtual memory mapping data structures (e.g., data structures for codifying the page table mapping 134_{1K}) accessible by guest operating system 157_{1K1} of VM 158_{1K1} and/or host operating system 156_{1K}. As the number of virtualized entities (e.g., VMs, executable containers, etc.) implemented at computing node 152_{1K} increases, the demands placed on the constrained RAM resources at the computing node also increase. Implementing memory paging or page swapping is one approach to mitigating such demands; however, as earlier described, executing page swaps for thousands (or more) computing processes at a computing node in a virtualized computing environment can be inefficient and can detrimentally impact the performance of computing processes and can detrimentally impact the performance of the computing system as a whole.

The herein disclosed techniques address such problems attendant to implementing efficient page swapping in virtualized computing environments that have a high demand for physical memory resources. Specifically, and as shown in the embodiment of FIG. 1, a virtualized swap framework 110_{1K} can be implemented at computing node 152_{1K} to facilitate virtualized memory paging from RAM device 142_{1K} to a random access persistent memory (RAPM) device (e.g., RAPM device 146_{1K}). As an example, a RAPM device (e.g., Intel Xpoint device) might exhibit a lower performance (e.g., longer access latency) as compared to a RAM device, but the RAPM device might cost less than the RAM device. The RAPM device might also be accessed over a serial bus or a parallel bus. The virtualized swap framework 110_{1K} is a collection of programming objects that can be executed in any component of the computing environment in which the programming objects are implemented. For example, the programming objects might be implemented in a swap device driver at the guest operating system of a VM, the hypervisor associated with the VM, and/or the host operating system of the computing node. As another example, the programming objects might comprise a set of specialized data structures designed to improve the way a computer stores and retrieves data in memory when performing steps pertaining to memory page swapping between the RAM device 142_{1K} and the RAPM device 146_{1K}.

Such programming objects of virtualized swap framework 110_{1K} might be used to configure RAPM device 146_{1K} as a swap device (operation 1). In certain embodiments, a block-addressable device 176_{1K} (e.g., an NVMe SSD) at computing node 152_{1K} might be configured as the swap device. The swap address space (e.g., swap address space 148_{1K1}, swap address space 148_{1K2}) of the swap device is apportioned into swap space portions that are assigned to respective VMs running in virtualized computing environment 100 (operation 2). For example, an assigned virtual swap space 124_{1K1} corresponding to a swap space portion from swap address space 148_{1K1} of RAPM device 146_{1K} might be assigned to VM 158_{1K1}.

Many operating systems expect a swap device to be a block-addressable storage device (e.g., an SSD, or an HDD, etc.) and will issue block-addressable requests to perform certain paging operations. In such cases, the virtualized swap framework 110_{1K} will emulate random access swap devices (e.g., RAPM device 146_{1K}) as block-addressable. For example, a block-addressable request might be issued from guest operating system 157_{1K1} of VM 158_{1K1} to request that a certain page of data at RAM device 142_{1K} be swapped to or from a logical block address associated with RAPM device 146_{1K} (e.g., the swap device). Such block-addressable requests are transformed into byte-addressable instructions to be issued to the RAPM device 146_{1K}. The byte-addressable instructions or block-addressable instructions are executed over the swap device (e.g., RAPM device 146_{1K} and/or block-addressable device 176_{1K}) to perform virtualized memory paging (operation 3).

A technique for performing virtualized memory paging is disclosed in further detail as follows.

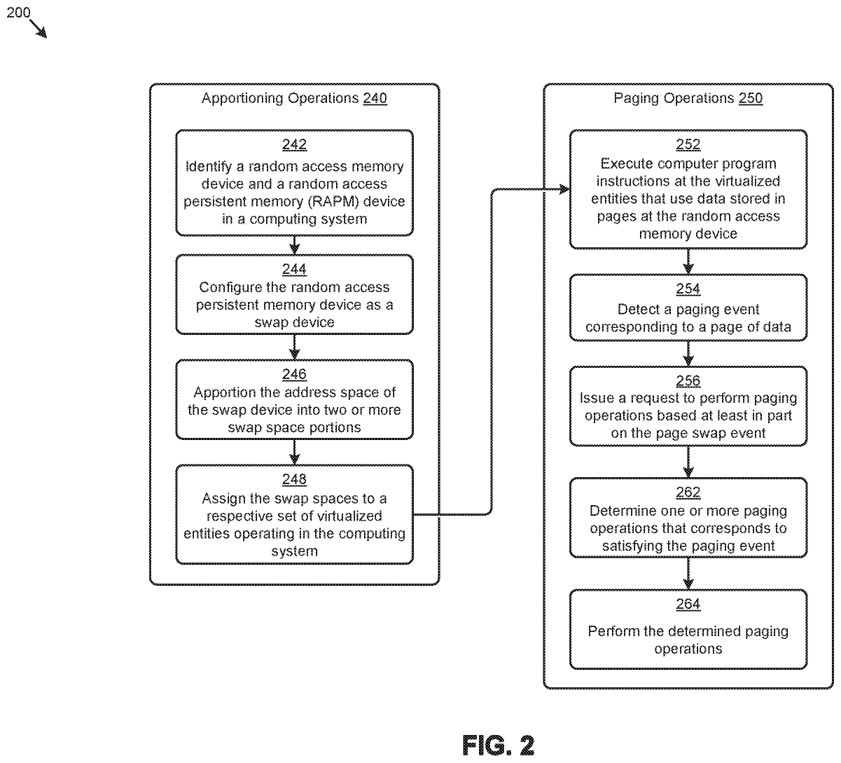

FIG. 2 depicts a virtualized memory paging technique 200 as implemented in systems that facilitate memory page swapping between a RAM device and a random access persistent memory device. As an option, one or more variations of a virtualized memory paging technique 200 or any aspect thereof may be implemented in the context of the architecture and functionality of the embodiments described herein. The virtualized memory paging technique 200 or any aspect thereof may be implemented in any environment.

The virtualized memory paging technique 200 presents one embodiment of certain steps and/or operations that facilitate management of multiple levels of metadata in distributed computing environments. As shown, the steps and/or operations can be grouped in a set of apportioning operations 240 and a set of paging operations 250. As illustrated, the apportioning operations 240 can commence by identifying a random access memory (RAM) device and a random access persistent memory (RAPM) device in a computing system (step 242). The RAPM device is configured as a swap device (step 244). A memory device configured as a swap device might be managed differently than a memory device not configured as a swap device. For example, the data stored in a swap device might not be subject to the replication and/or retention policies that are applied to other stored data (e.g., in virtual disks) in the computing system. The address space of the swap device is apportioned into one or more swap space portions (step 246). The swap space portions are assigned to a respective set of virtualized entities operation in the computing system (step 248).

The paging operations 250 can commence by executing computer program instructions at the virtualized entities that use data stored in pages at the RAM device (step 252). In response to detecting a paging event corresponding to the page of data (step 254), a request to perform a paging operation is issued (step 256).

Step 262 serves to determine one or more paging operations that corresponds to satisfying the paging event. For example, a page swap event might correspond to a page fault event that occurs during execution of the computer program instructions. In this case, the request might be a “page-in” operation to move the page of data from the swap device (e.g., RAPM device) to the RAM device. As another example, the paging event might correspond to an operating system kernel demand that a certain amount of address space is to be made available to execute the computer program instructions. In this case, the request might be a “page-out” operation to move the page of data from the RAM device to the swap device (e.g., RAPM device). At any time, and for any kernel-determined reason, an operating system facility might identify a page of data to be swapped out based on a least recently used (LRU) algorithm. Step 264 performs the determined paging operations so as to fulfill the request (e.g., to page-in data or to page-out data).

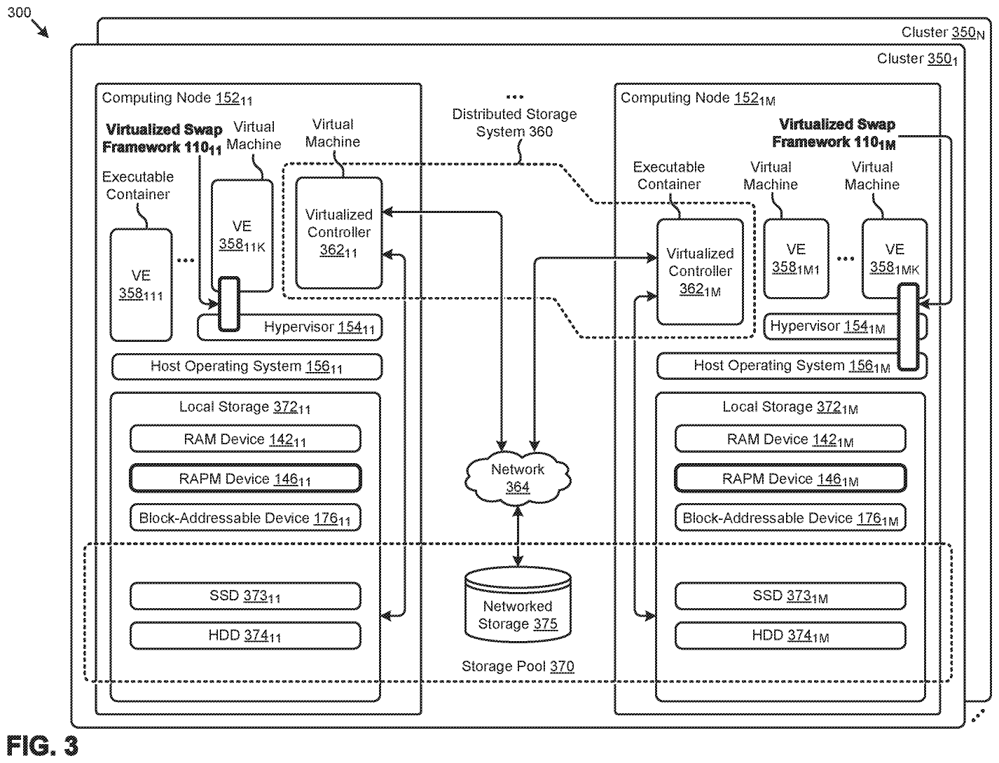

An example of a distributed computing environment (e.g., distributed virtualization environment, etc.) that supports any of the herein disclosed techniques is presented and discussed as pertains to FIG. 3.

FIG. 3 illustrates a distributed virtualization environment 300 in which embodiments of the present disclosure can be implemented. As an option, one or more variations of a distributed virtualization environment 300 or any aspect thereof may be implemented in the context of the architecture and functionality of the embodiments described herein.

The shown distributed virtualization environment depicts various components associated with one instance of a distributed virtualization system (e.g., hyperconverged distributed system) comprising a distributed storage system 360 that can be used to implement the herein disclosed techniques. Specifically, the distributed virtualization environment 300 comprises multiple clusters (e.g., cluster 350₁, . . . , cluster 350_{N}) comprising multiple nodes that have multiple tiers of storage in a storage pool. Representative nodes (e.g., computing node 152₁₁, . . . , computing node 152_{1M}) and storage pool 370 associated with cluster 350₁ are shown. Each node can be associated with one server, multiple servers, or portions of a server. The nodes can be associated (e.g., logically and/or physically) with the clusters. As shown, the multiple tiers of storage include storage that is accessible through a network 364, such as a networked storage 375 (e.g., a storage area network or SAN, network attached storage or NAS, etc.).

The multiple tiers of storage further include instances of local storage (e.g., local storage 372₁₁, . . . , local storage 372_{1M}). For example, the local storage can be within or directly attached to a server and/or appliance associated with the nodes. Such local storage can include solid state drives (SSD 373₁₁, . . . , SSD 373_{1M}), hard disk drives (HDD 374₁₁, . . . , HDD 374_{1M}), and/or other storage devices. As further shown, memory storage at the nodes can also include RAM devices (RAM device 142₁₁, . . . , RAM device 142_{1M}), RAPM devices (RAPM device 146₁₁, . . . , RAPM device 146_{1M}), and other intra-node block-addressable devices (block-addressable device 176₁₁, . . . , block-addressable device 176_{1M}). In certain embodiments, one or more of the RAPM devices and/or the block-addressable devices can be configured as a swap device according to the herein disclosed techniques.

As shown, the nodes in the distributed virtualization environment 300 can implement one or more user virtualized entities (e.g., VE 358₁₁₁, VE 358_{11K}, . . . , VE 358_{1M1}, VE 358_{1MK}), such as virtual machines (VMs) and/or containers. The VMs can be characterized as software-based computing “machines” implemented in a hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 156₁₁, . . . , host operating system 156_{1M}), while the VMs run multiple applications on various respective guest operating systems. Such flexibility can be facilitated at least in part by a hypervisor (e.g., hypervisor 154₁₁, . . . , hypervisor 154_{1M}), which hypervisor is logically located between the various guest operating systems of the VMs and the host operating system of the physical infrastructure (e.g., node).

As an example, hypervisors can be implemented using virtualization software (e.g., VMware ESXi, Microsoft Hyper-V, RedHat KVM, Nutanix AHV, etc.) that includes a hypervisor. In comparison, the containers (e.g., application containers or ACs) are implemented at the nodes in an operating system virtualization environment or container virtualization environment. The containers comprise groups of processes and/or resources (e.g., memory, CPU, disk, etc.) that are isolated from the node host computer and other containers. Such containers directly interface with the kernel of the host operating system (e.g., host operating system 156₁₁, . . . , host operating system 156_{1M}) without, in most cases, a hypervisor layer. This lightweight implementation can facilitate efficient distribution of certain software components, such as applications or services (e.g., micro-services). As shown, the distributed virtualization environment 300 can implement both a hypervisor-assisted virtualization environment and a container virtualization environment for various purposes.

The distributed virtualization environment 300 also comprises at least one instance of a virtualized controller to facilitate access to storage pool 370 by the VMs and/or containers.

As used in these embodiments, a virtualized controller is a collection of software instructions that serve to abstract details of underlying hardware or software components from one or more higher-level processing entities. A virtualized controller can be implemented as a virtual machine, as a container (e.g., a Docker container), or within a layer (e.g., such as a layer in a hypervisor).

Multiple instances of such virtualized controllers can coordinate within a cluster to form the distributed storage system 360 which can, among other operations, manage the storage pool 370. This architecture further facilitates efficient scaling of the distributed virtualization system. The foregoing virtualized controllers can be implemented in the distributed virtualization environment 300 using various techniques. Specifically, an instance of a virtual machine at a given node can be used as a virtualized controller in a hypervisor-assisted virtualization environment to manage storage and I/O (input/output or IO) activities. In this case, for example, the virtualized entities at computing node 152₁₁ can interface with a controller virtual machine (e.g., virtualized controller 362₁₁) through hypervisor 154₁₁ to access storage pool 370. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with distributed storage system 360.

For example, a hypervisor at one node in distributed storage system 360 might correspond to VMware ESXi software, and a hypervisor at another node in distributed storage system 360 might correspond to Nutanix AHV software. As another virtualized controller implementation example, containers (e.g., Docker containers) can be used to implement a virtualized controller (e.g., virtualized controller 362_{1M}) in an operating system virtualization environment at a given node. In this case, for example, the virtualized entities at computing node 152_{1M} can access storage pool 370 by interfacing with a controller container (e.g., virtualized controller 362_{1M}) through hypervisor 154_{1M} and/or the kernel of host operating system 156_{1M}.

In certain embodiments, one or more instances of a virtualized swap framework can be implemented over any of the components in the distributed virtualization environment 300 to facilitate the herein disclosed techniques. Specifically, virtualized swap framework 110₁₁ can be implemented in one or more VEs (e.g., VE 358_{11K}) and/or one or more hypervisors (e.g., hypervisor 154₁₁) of computing node 152₁₁, and virtualized swap framework 110_{1M} can be implemented in one or more VEs (e.g., VE 358_{1MK}), one or more hypervisors (e.g., hypervisor 154_{1M}), and/or host operating system 156_{1M} of computing node 152_{1M}. Such instances of the virtualized swap framework can be implemented in any node in any cluster. Actions taken by one or more instances of the virtualized swap framework can apply to a node (or between nodes), and/or to a cluster (or between clusters), and/or between any resources or subsystems accessible by the virtualized swap framework, the virtualized controllers, and/or their agents.

The foregoing discussion pertains to certain apportioning operations which are disclosed in further detail as follows.

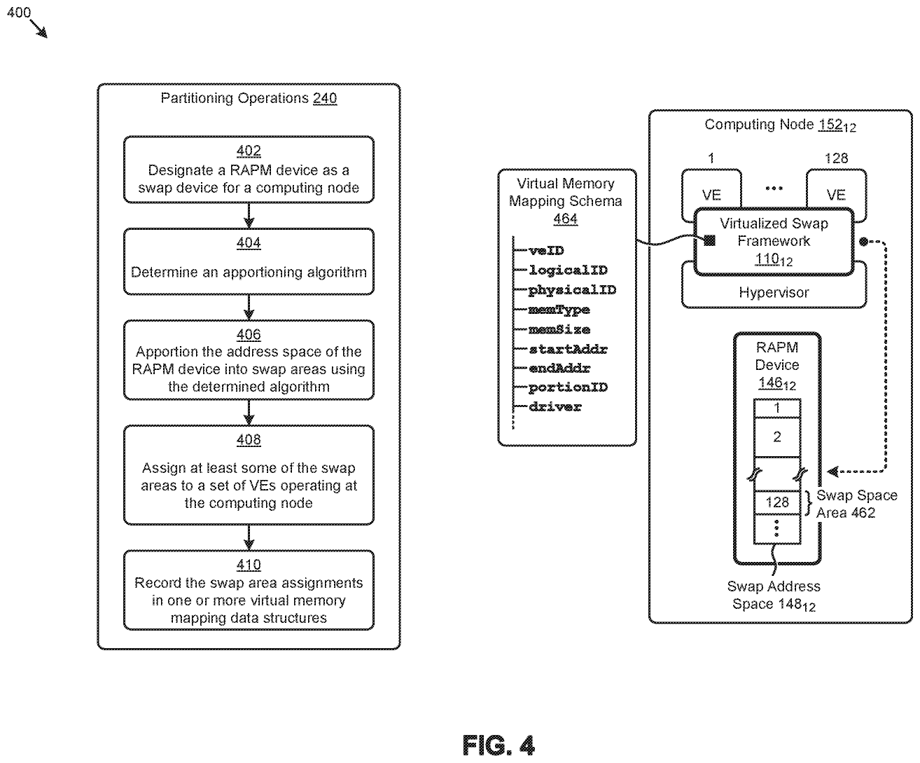

FIG. 4 presents a swap memory virtualization technique 400 as implemented in systems that facilitate memory page swapping between a RAM device and a random access persistent memory device. As an option, one or more variations of a swap memory virtualization technique 400 or any aspect thereof may be implemented in the context of the architecture and functionality of the embodiments described herein. The swap memory virtualization technique 400 or any aspect thereof may be implemented in any environment.

The swap memory virtualization technique 400 presents one embodiment of certain steps and/or operations that virtualized a swap address space to facilitate memory page swapping between a RAM device and a random access persistent memory device. A representative computing node (e.g., computing node 152₁₂) is shown to further illustrate the swap memory virtualization technique 400. Certain specialized data structures (e.g., virtual memory mapping schema 464) that are designed to improve the way a computer stores and retrieves data in memory when performing such techniques are also discussed. As shown, the steps and/or operations of the swap memory virtualization technique 400 comprise an embodiment of apportioning operations 240 earlier described.

The swap memory virtualization technique 400 can commence with designating a random access persistent memory (RAPM) device as a swap device for a computing node (step 402). For example, RAPM device 146₁₂ at computing node 152₁₂ can be designated as a swap device for the node. In certain embodiments, components of virtualized swap framework 110₁₂ might enumerate the devices available at computing node 152₁₂ to identify a suitable swap device. At step 404, an apportioning algorithm is determined. For example, equally-sized swap areas of the RAPM device are formed to cover the address range of the RAPM, or, a maximum number of virtualized entities (VEs) that can be implemented at the computing node is determined and swap areas are sized based on that metric. For example, the maximum virtualized entity quantity (e.g., 128) might be determined by dividing the random access memory size (e.g., 256 GB) at the computing node by the maximum virtual memory size (e.g., 2 GB) that can be allocated to a virtualized entity.

In some cases, the maximum virtual memory size that can be allocated to a virtualized entity can be defined statically. In other cases, an algorithm that apportions (e.g., in a pro-rata apportionment) based on an allocation request derived from a VE configuration can be used. In still other cases, the virtual memory size that is allocated to a virtualized entity can result from a dynamic assignment based on then-current conditions. For example, the virtual memory amount that is allocated to a particular virtualized entity can be based on that particular virtualized entity's share of swap space as a portion taken from a swap pool that is shared by a plurality of virtual machines and/or other types of VEs. In some cases, the specific portion that is allocated to a particular VE is derived from parameters pertaining to a swap pool that is managed by the host operating system.

Returning to the discussion of FIG. 4, a particular algorithm (e.g., such as heretofore described) is used to apportion all or part of the address space of the swap device (step 406). As shown, all or a portion of swap address space 148₁₂ of RAPM device 146₁₂ is apportioned into 128 swap areas (e.g., swap space area 462). At least some of the swap space areas are assigned to a respective set of VEs operating at the computing node (step 408). For example, at a certain moment in time, the first 50 of the 128 swap space areas might be assigned to a set of 50 VEs created at the computing node at that same moment in time. The swap space area assignments are recorded in one or more virtual memory mapping data structures (step 410).

Virtual memory mapping data structures as referred to herein are data structures in a computing system that codify information that relates certain virtual memory attributes to physical memory attributes and/or other virtual memory attributes. The virtual memory mapping data structures can further codify other information pertaining to other constituents (e.g., virtualized entities, physical storage devices, virtual storage containers, etc.) of a computing system. Various instances of the virtual memory mapping data structures can be implemented throughout the virtualized swap framework and/or the computing nodes to facilitate the herein disclosed techniques.

The information (e.g., the swap space area assignments) stored in the virtual memory mapping data structures and/or any data structure described herein can be organized and/or stored using various techniques. For example, the virtual memory mapping schema 464 indicates the information might be organized and/or stored in a tabular structure (e.g., relational database table) that has rows that relate various virtual memory attributes with a particular virtualized entity. As another example, the information might be organized and/or stored in a programming code object that has instances corresponding to a particular virtualized entity and properties corresponding to the various virtual memory attributes associated with the virtualized entity.

As depicted in virtual memory mapping schema 464, a data record (e.g., table row or object instance) for a particular virtualized entity might describe a virtualized entity identifier (e.g., stored in a “veID” field), a logical device identifier (e.g., stored in a “logicalID” field), a physical device identifier (e.g., stored in a “physicalID” field), a memory type (e.g., “swap” stored in a “memType” field), a memory size (e.g., stored in a “memSize” field), a block or portion start address (e.g., stored in a “startAddr” field), a block or portion end address (e.g., stored in a “endAddr” field), a portion name or identifier (e.g., stored in a “portionID” field), a logical or physical device driver identifier or URI (e.g., stored in a “driver” field), and/or other virtual memory mapping attributes.

Various techniques for implementing the earlier discussed paging operations of FIG. 2 are disclosed as follows.

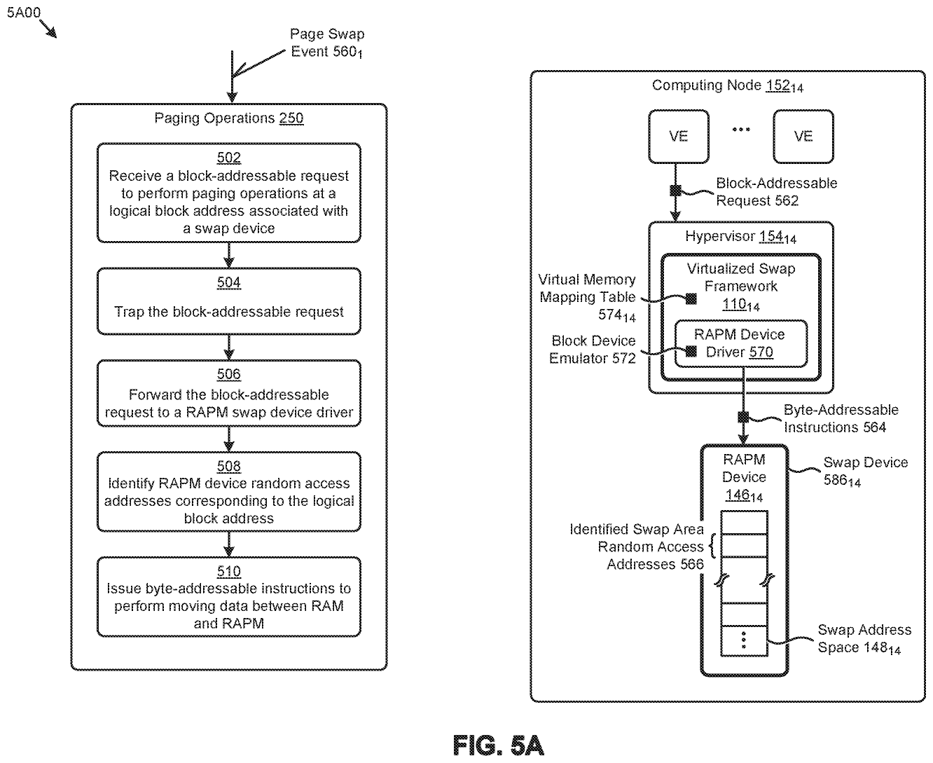

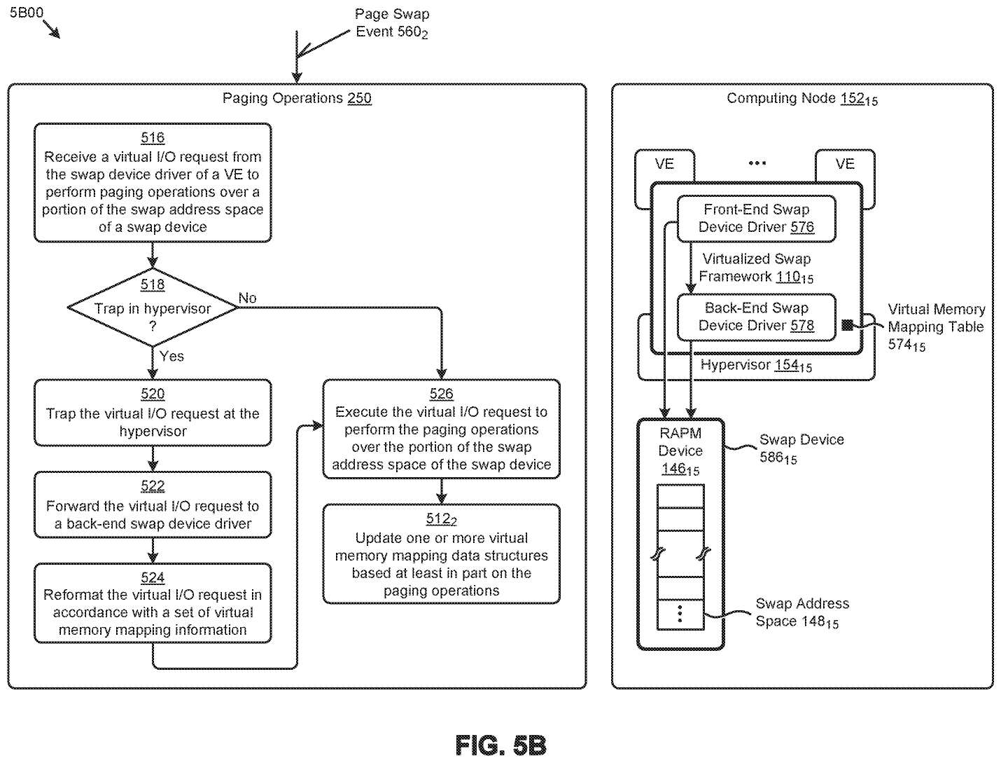

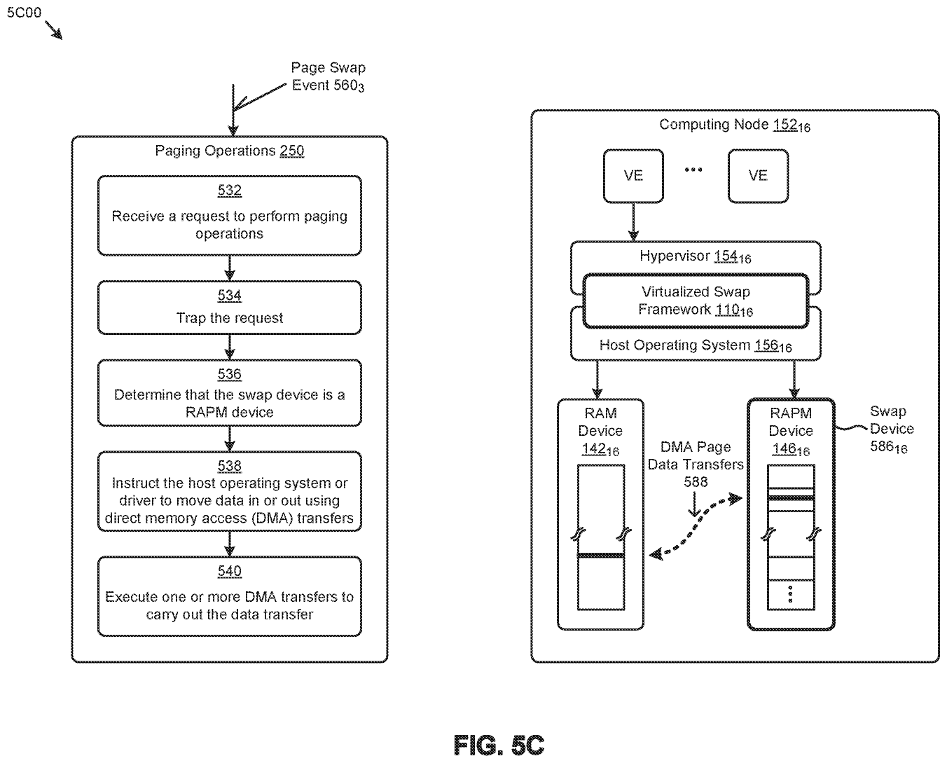

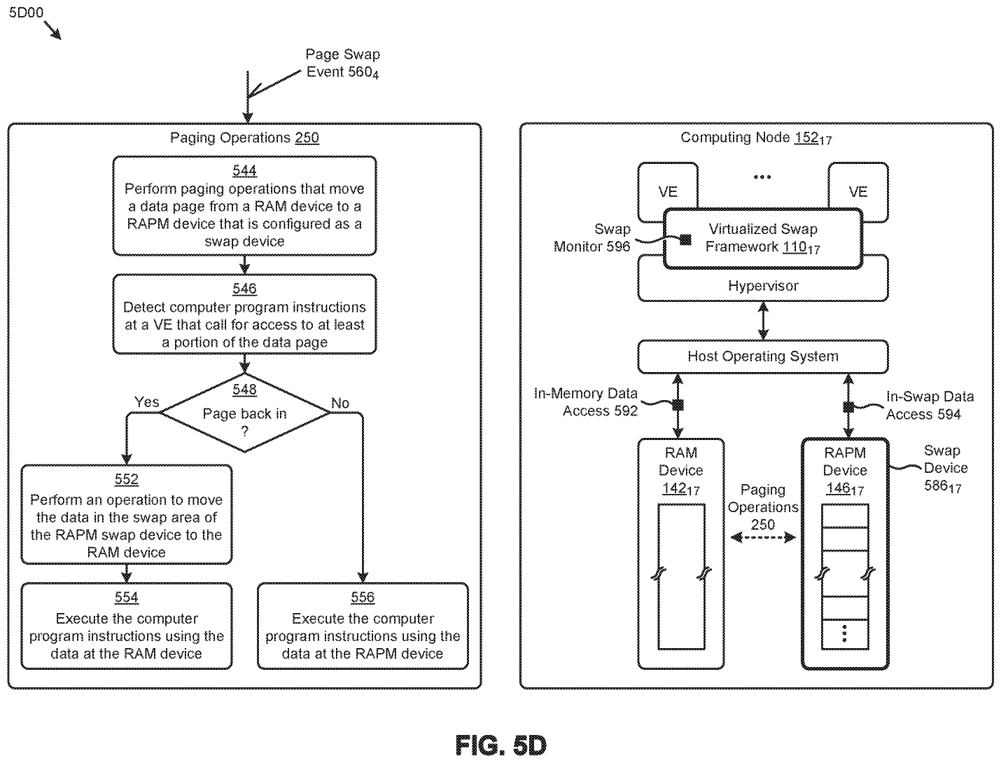

FIG. 5A depicts a block device emulation technique 5A00 as implemented in systems that facilitate memory page swapping between a RAM device and a random access persistent memory device. As an option, one or more variations of a block device emulation technique 5A00 or any aspect thereof may be implemented in the context of the architecture and functionality of the embodiments described herein. The block device emulation technique 5A00 or any aspect thereof may be implemented in any environment.

The block device emulation technique 5A00 presents one embodiment of certain steps and/or operations that facilitate block device emulation of an RAPM swap device. Such a block device emulation technique might be implemented in computing environments with operating systems (e.g., guest operating systems, host operating systems, etc.) that are designed to interface with swap devices that are block-addressable. A representative computing node (e.g., computing node 152₁₄) is shown to further illustrate the block device emulation technique 5A00. As shown, the steps and/or operations of the block device emulation technique 5A00 comprise an embodiment of the paging operations 250 earlier described. Such paging operations can be invoked by a page swap event 560₁.

The block device emulation technique 5A00 can commence in response to the page swap event by receiving a block-addressable request to perform certain paging operations at a logical block address associated with a swap device (step 502). For example, RAPM device 146₁₄ at computing node 152₁₄ might be designated as a swap device 586₁₄ for the node, and a block-addressable request 562 (e.g., LBA request) might be issued to perform a paging operation (e.g., page-in request, page-out request, etc.) at swap device 586₁₄. The block-addressable request is trapped by an operating system or hypervisor function (step 504).

For example, and as shown, virtualized swap framework 110₁₄ might have components operating at hypervisor 154₁₄ to intercept any paging requests. The trapped block-addressable request is forwarded to a RAPM swap device driver (step 506). In some cases, a virtual memory mapping data structure (e.g., virtual memory mapping table 574₁₄) might be consulted to identify a RAPM swap device driver 570 to receive the forwarded request. The RAPM swap device driver 570 might also consult the virtual memory mapping table 574₁₄ to identify the RAPM device addresses (e.g., from swap address space 148₁₄ of swap device 586₁₄) corresponding to the logical block address of block-addressable request 562 (step 508). A set of byte-addressable instructions are then issued to perform the paging operations to/from the identified swap area addresses (step 510). More specifically, a block device emulator 572 at RAPM swap device driver 570 in virtualized swap framework 110₁₄ transforms a block-addressable request and its attributes (e.g., logical device identifier, logical block address, request type, virtual address, etc.) into one or more byte-addressable instructions 564 that are issued to perform transfers of data between RAM and the identified swap area random access addresses 566 of the RAPM device 14614. One or more virtual memory mapping data structures (e.g., page tables) are updated based at least in part on the performed data transfers.

FIG. 5B illustrates a virtual I/O swap device access technique 5B00 as implemented in systems that facilitate memory page swapping between a RAM device and a random access persistent memory device. As an option, one or more variations of a virtual I/O swap device access technique 5B00 or any aspect thereof may be implemented in the context of the architecture and functionality of the embodiments described herein. The virtual I/O swap device access technique 5B00 or any aspect thereof may be implemented in any environment.

The virtual I/O swap device access technique 5B00 presents one embodiment of certain steps and/or operations that facilitate virtual I/O access to swap devices in systems that facilitate memory page swapping between a RAM device and a RAPM device. As an example, the virtual I/O swap device access technique 5B00 might be implemented in computing environments with operating systems (e.g., guest operating systems) and/or hypervisors that can be designed to include specialized device drivers that have virtual I/O functionality. A representative computing node (e.g., computing node 152₁₅) is shown to further illustrate the virtual I/O swap device access technique 5B00. As shown, the steps and/or operations of the virtual I/O swap device access technique 5B00 comprise an embodiment of paging operations 250 earlier described. Such paging operations can be invoked by a page swap event 560₂.

The virtual I/O swap device access technique 5B00 can commence in response to the page swap event by receiving a virtual I/O request from the swap device driver of a VE to perform certain paging operations over a portion of the swap address space of a swap device (step 516). For example, RAPM device 146₁₅ at computing node 152₁₅ might be designated as a swap device 586₁₅ for the node, and a virtual I/O request might be issued from a VE to perform paging operations (e.g., page-in request, page-out request, etc.) at swap device 586₁₅.

In at least one embodiment, a front-end swap device driver 576 (e.g., a paravirtualized front-end driver) might be implemented in virtualized swap framework 110₁₅ (e.g., in the VE guest operating system) to issue requests to a swap device that are trapped in a hypervisor (e.g., hypervisor 154₁₅) (see “Yes” path of decision 518). In this case, the virtual I/O request is trapped at the hypervisor (step 520) and forwarded to a back-end swap device driver 578 (step 522). The virtual I/O request is reformatted (e.g., by the back-end swap device driver 578) in accordance with a set of virtual memory mapping information (e.g., virtual memory mapping table 574₁₅) (step 524). For example, the virtual I/O request might be reformatted based at least in part on a mapping between the virtual address space at the VE and swap address space 148₁₅ of swap device 586₁₅.

In certain embodiments, the virtual I/O request from the swap device driver of the VE might be issued directly to the swap device without a hypervisor trap (see “No” path of decision 518). As an example, a swap device presented as a virtual device function using single root I/O virtualization (SR-IOV) can be accessed by the VE guest operating system directly. The virtual I/O request is issued directly from the VE or trapped and/or reformatted by the hypervisor and is executed over the target portion of the swap address space of the swap device (step 526). One or more virtual memory mapping data structures (e.g., page tables) are updated based at least in part on the paging operations performed (step 512₂).

FIG. 5C presents a direct memory access paging technique 5C00 as implemented in systems that facilitate memory page swapping between a RAM device and a random access persistent memory device. As an option, one or more variations of direct memory access paging technique 5C00 or any aspect thereof may be implemented in the context of the architecture and functionality of the embodiments described herein. The direct memory access paging technique 5C00 or any aspect thereof may be implemented in any environment.

The direct memory access paging technique 5C00 presents one embodiment of certain steps and/or operations that facilitate memory page swapping between a RAM device and a RAPM device using direct memory access techniques. As an example, the direct memory access paging technique 5C00 might be implemented in systems that configure a byte-addressable and/or random access memory device, such as a RAPM device, as the swap device. A representative computing node (e.g., computing node 152₁₆) is shown to further illustrate the direct memory access paging technique 5C00. As shown, the steps and/or operations of the direct memory access paging technique 5C00 comprise an embodiment of paging operations 250 earlier described. Such paging operations can be invoked by a page swap event 560₃.

The direct memory access paging technique 5C00 can commence in response to the page swap event by receiving a request to perform paging operations at a swap device (step 532). For example, RAPM device 146₁₆ at computing node 152₁₆ might be designated as a swap device 586₁₆ for the node, and a request might be issued from a VE to perform paging operations (e.g., page-in request, page-out request, etc.) at swap device 586₁₆. The request is trapped (e.g., at hypervisor 154₁₆) (step 534). The swap device associated with the trapped request is determined to be a random access device (step 536).

For example, an instance of a virtualized swap framework 110₁₆ implemented over hypervisor 154₁₆ and host operating system 156₁₆ might consult certain virtual memory mapping data structures to determine the swap device type. At step 538, the host operating system or driver issues instructions to move data in or out using direct memory access (DMA) transfers. Such DMA data transfers are executed to carry out the data transfer (step 540). As can be observed in the illustrated example, DMA page data transfers 588 invoked by host operating system 156₁₆ can be executed between RAM device 142₁₆ and RAPM device 146₁₆. One or more virtual memory mapping data structures (e.g., page tables) are updated based at least in part on the operations performed.

FIG. 5D depicts a swap device data access technique 5D00 as implemented in systems that facilitate memory page swapping between a RAM device and a random access persistent memory device. As an option, one or more variations of swap device data access technique 5D00 or any aspect thereof may be implemented in the context of the architecture and functionality of the embodiments described herein. The swap device data access technique 5D00 or any aspect thereof may be implemented in any environment.

The swap device data access technique 5D00 presents one embodiment of certain steps and/or operations that facilitate accessing the data in a swap device to facilitate execution of computer program instructions. As an example, the swap device data access technique 5D00 might be implemented in systems with swap devices (e.g., RAPM devices) that facilitate random access and/or low latency access. A representative computing node (e.g., computing node 152₁₇) is shown to further illustrate the swap device data access technique 5D00.

The swap device data access technique 5D00 can commence by responding to a page swap event 560₄, after which certain of the paging operations 250 move at least one data page from a RAM device to a RAPM device that is configured as a swap device (step 544). For example, RAPM device 146₁₇ at computing node 152₁₇ might be designated as a swap device 586₁₇ for the node, and receive the data page from RAM device 142₁₇ in response to certain paging operations. Certain computer program instructions executing at a VE might expect at least a portion of the data page that is moved to the swap device to be in memory. When such instructions are detected (step 546), a determination is made as to whether the data page should be swapped back into the RAM device (decision 548).

For example, a swap monitor 596 implemented in virtualized swap framework 110₁₇ can determine the frequencies of requests for data at swap device 586₁₇. If swap monitor 596 determines the data page is to be swapped back into memory (see “Yes” path of decision 548), then certain operations to move the data page from the swap device to the RAM device are performed (step 552). The computer program instructions can then be executed using in-memory data access 592 to access the data page at RAM device 142₁₇ (step 554).

The swap monitor can make determinations using any technique. In some cases, a page counter for each page in memory is updated after each access. As such, a particular page can be determined to be “hot” or at least more frequently accessed than other pages. In some architectures, such a set of counters are provided by a page table or other facility of a memory management unit. For example, some CPU/memory architectures might have a clearable “accessed” register (e.g., in a set of registers and/or in a memory-mapped area) that is set when a page is accessed (e.g., by a memory management unit), and cleared under programmatic control. The “accessed” bit is sampled and cleared periodically. Longer contiguous strings of a “set” value across multiple periods yields an indication that a particular page is frequently accessed. As such, the swap monitor might make determinations based on the length of contiguous strings of a “set” value across multiple periods.

Another approach to making page-out determinations is to use statistical sampling. A programmatic process or thread interrupts the CPU periodically to determine what memory location it is accessing at the time. A pattern on a particular page over time yields an indication as to whether or not a particular page is frequently accessed.

If the swap monitor 596 determines the data page can remain at the swap device (see “No” path of decision 548), the computer program instructions can be executed using in-swap data access 594 to access the data page at RAPM device 146₁₇ (step 556). As such, the program instructions can be executed by accessing the RAPM device 146₁₇ via random access addressing. Furthermore, there may be data that is accessible via random access addressing, which data may be in forms other than program instructions. Such non-instruction data can be accessed at RAPM device 146₁₇ via random access addressing. In many situations, the non-instruction data is computer data that is accessed (e.g., read or written) by an instruction processor during program code execution.

In some cases, decision 548 is based on a statistical analysis that determines that a least-frequently-used (LFU) or most-frequently-used (MFU) condition is met such that the data in a swap area of the RAPM should be brought back into RAM. In some cases, decision 548 is based on a situation where least-recently-used (LRU) or most-recently-used (MRU) condition is met such that the data in a swap area of the RAPM should be brought back into RAM. In still other cases, decision 548 is based at least in part on a hardware-assisted facility that employs a lookaside table to perform automatic logging such that least-frequently-used and/or most-frequently-used swap areas can be identified and then used to determine if/when instructions and/or non-instruction data in a swap area of the RAPM should be brought into RAM.

### Additional Embodiments of the Disclosure

### Additional Practical Application Examples

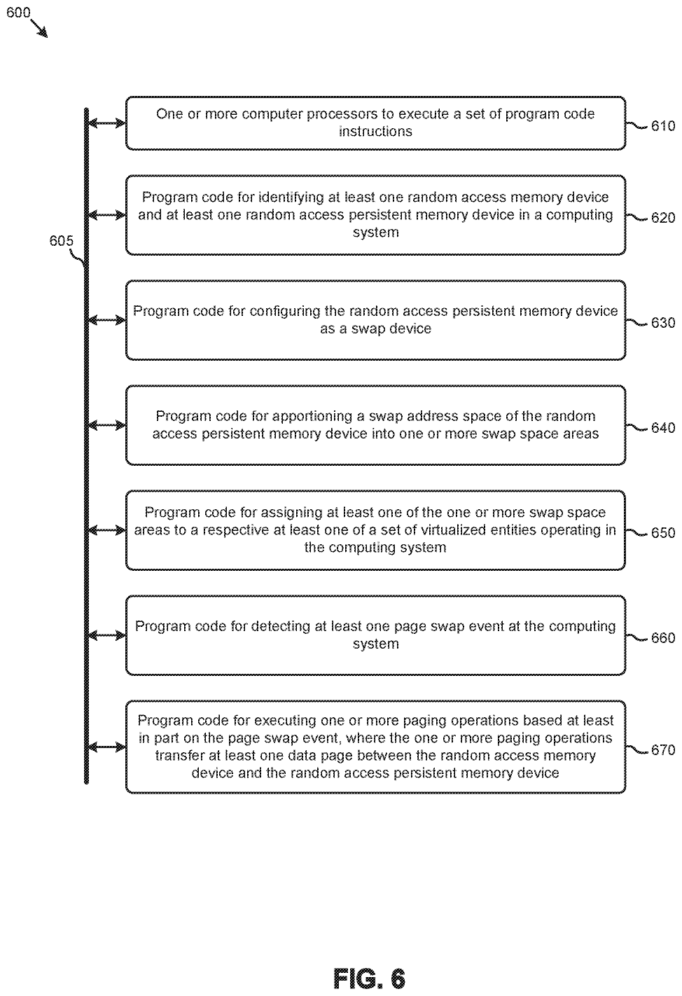

FIG. 6 depicts a system 600 as an arrangement of computing modules that are interconnected so as to operate cooperatively to implement certain of the herein-disclosed embodiments. This and other embodiments present particular arrangements of elements that, individually and/or as combined, serve to form improved technological processes that address efficiently implementing page swapping in virtualized computing environments that have a high demand for physical memory resources. The partitioning of system 600 is merely illustrative and other partitions are possible. As an option, the system 600 may be implemented in the context of the architecture and functionality of the embodiments described herein. Of course, however, the system 600 or any operation therein may be carried out in any desired environment.

The system 600 comprises at least one processor and at least one memory, the memory serving to store program instructions corresponding to the operations of the system. As shown, an operation can be implemented in whole or in part using program instructions accessible by a module. The modules are connected to a communication path 605, and any operation can communicate with other operations over communication path 605. The modules of the system can, individually or in combination, perform method operations within system 600. Any operations performed within system 600 may be performed in any order unless as may be specified in the claims.

The shown embodiment implements a portion of a computer system, presented as system 600, comprising one or more computer processors to execute a set of program code instructions (module 610) and modules for accessing memory to hold program code instructions to perform: identifying at least one random access memory device and at least one random access persistent memory device in a computing system (module 620); configuring the random access persistent memory device as a swap device (module 630); apportioning a swap address space of the random access persistent memory device into two or more swap space areas (module 640); assigning at least one of the swap space areas to a respective at least one of a set of virtualized entities operating in the computing system (module 650); detecting at least one page swap event at the computing system (module 660); and executing one or more paging operations based at least in part on the page swap event, where the one or more paging operations transfer at least one data page between the random access memory device and the random access persistent memory device (module 670).

Variations of the foregoing may include more or fewer of the shown modules. Certain variations may perform more or fewer (or different) steps, and/or certain variations may use data elements in more, or in fewer (or different) operations. Still further, some embodiments include variations in the operations performed, and some embodiments include variations of aspects of the data elements used in the operations.

### System Architecture Overview

### Additional System Architecture Examples

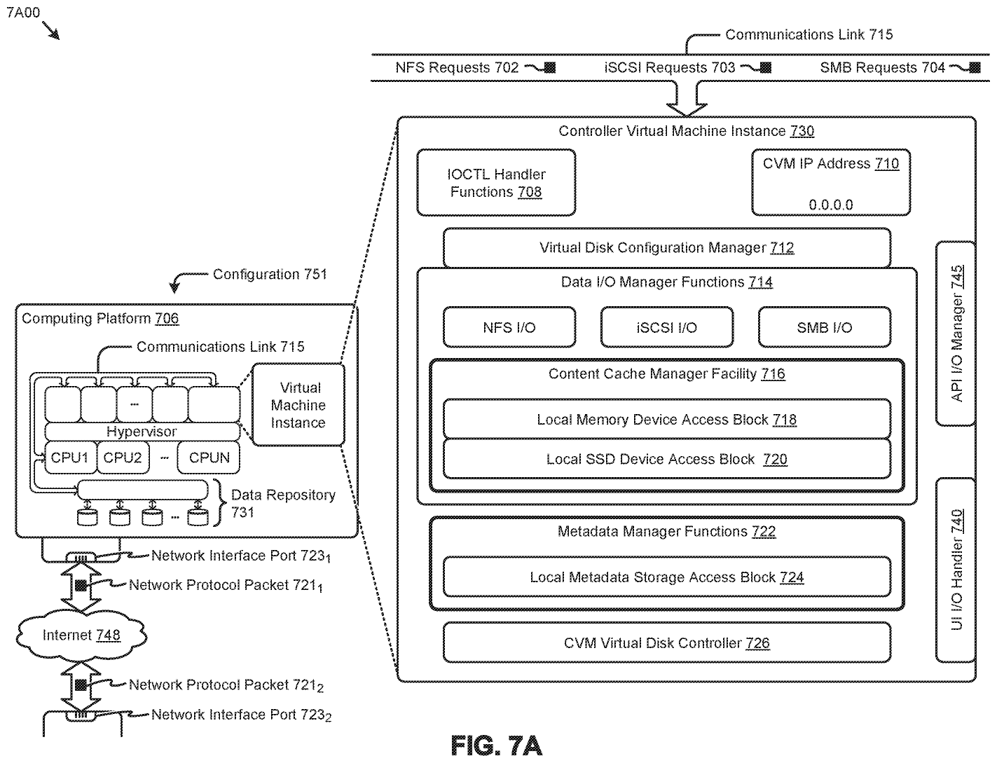

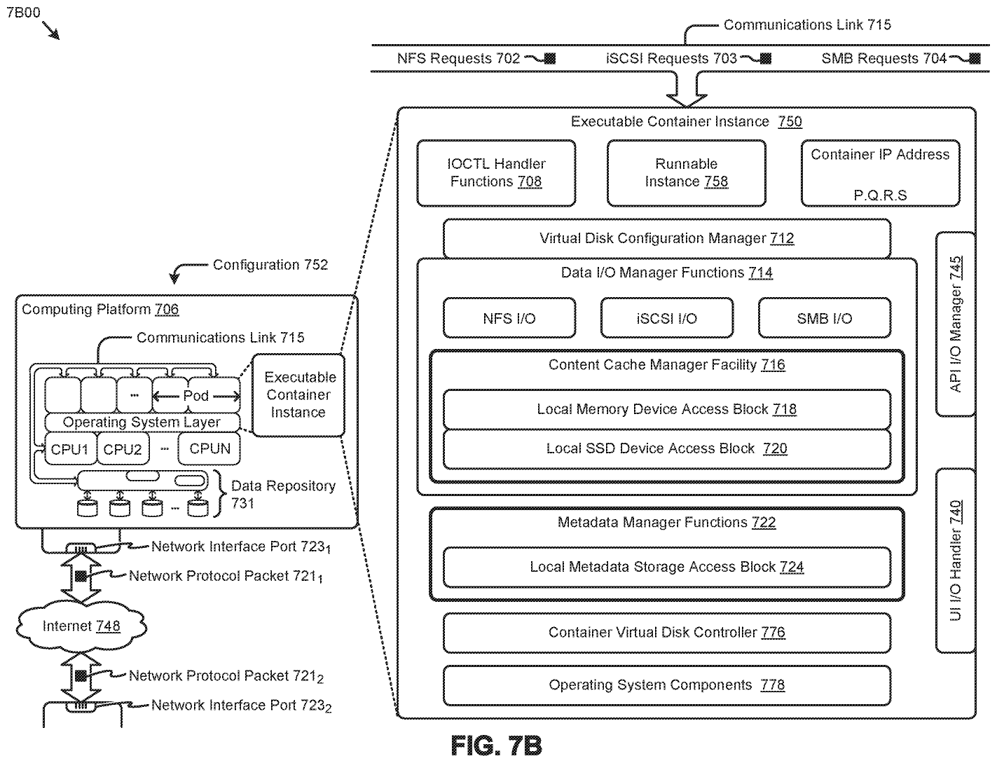

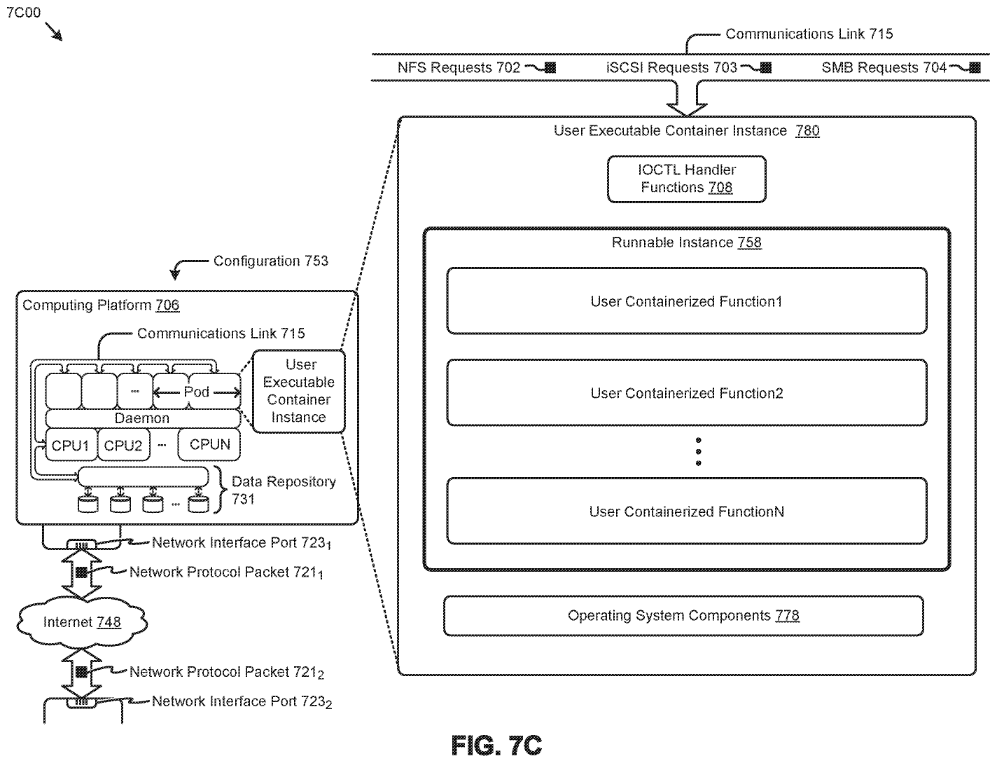

FIG. 7A depicts a virtualized controller as implemented by the shown virtual machine architecture 7A00. The heretofore-disclosed embodiments, including variations of any virtualized controllers, can be implemented in distributed systems where a plurality of networked-connected devices communicate and coordinate actions using inter-component messaging. Distributed systems are systems of interconnected components that are designed for, or dedicated to, storage operations as well as being designed for, or dedicated to, computing and/or networking operations. Interconnected components in a distributed system can operate cooperatively to achieve a particular objective, such as to provide high performance computing, high performance networking capabilities, and/or high performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, the virtual machine architecture 7A00 comprises a collection of interconnected components suitable for implementing embodiments of the present disclosure and/or for use in the herein-described environments. Moreover, the virtual machine architecture 7A00 includes a virtual machine instance in configuration 751 that is further described as pertaining to controller virtual machine instance 730. Configuration 751 supports virtual machine instances that are deployed as user virtual machines, or controller virtual machines or both. Such virtual machines interface with a hypervisor (as shown). Some virtual machines include processing of storage I/O (input/output or IO) as received from any or every source within the computing platform. An example implementation of such a virtual machine that processes storage I/O is depicted as 730.

In this and other configurations, a controller virtual machine instance receives block I/O (input/output or IO) storage requests as network file system (NFS) requests in the form of NFS requests 702, and/or internet small computer storage interface (iSCSI) block IO requests in the form of iSCSI requests 703, and/or Samba file system (SMB) requests in the form of SMB requests 704. The controller virtual machine (CVM) instance publishes and responds to an internet protocol (IP) address (e.g., CVM IP address 710). Various forms of input and output (I/O or IO) can be handled by one or more IO control handler functions (e.g., IOCTL handler functions 708) that interface to other functions such as data IO manager functions 714 and/or metadata manager functions 722. As shown, the data IO manager functions can include communication with virtual disk configuration manager 712 and/or can include direct or indirect communication with any of various block IO functions (e.g., NFS IO, iSCSI IO, SMB IO, etc.).

In addition to block IO functions, configuration 751 supports IO of any form (e.g., block IO, streaming IO, packet-based IO, HTTP traffic, etc.) through either or both of a user interface (UI) handler such as UI IO handler 740 and/or through any of a range of application programming interfaces (APIs), possibly through API IO manager 745.

Communications link 715 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as random access memory. As shown, controller virtual machine instance 730 includes content cache manager facility 716 that accesses storage locations, possibly including local dynamic random access memory (DRAM) (e.g., through the local memory device access block 718) and/or possibly including accesses to local solid state storage (e.g., through local SSD device access block 720).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 731, which in turn can be formatted into any one or more storage areas, and which can comprise parameterized storage accessible by a key (e.g., a filename, a table name, a block address, an offset address, etc.). External data repository 731 can store any forms of data, and may comprise a storage area dedicated to storage of metadata pertaining to the stored forms of data. In some cases, metadata can be divided into portions. Such portions and/or cache copies can be stored in the external storage data repository and/or in a local storage area (e.g., in local DRAM areas and/or in local SSD areas). Such local storage can be accessed using functions provided by local metadata storage access block 724. External data repository 731 can be configured using CVM virtual disk controller 726, which can in turn manage any number or any configuration of virtual disks.

Execution of the sequences of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 751 can be coupled by communications link 715 (e.g., backplane, LAN, PSTN, wired or wireless network, etc.) and each instance may perform respective portions of sequences of instructions as may be required to practice embodiments of the disclosure.

The shown computing platform 706 is interconnected to the Internet 748 through one or more network interface ports (e.g., network interface port 723₁ and network interface port 723₂). Configuration 751 can be addressed through one or more network interface ports using an IP address. Any operational element within computing platform 706 can perform sending and receiving operations using any of a range of network protocols, possibly including network protocols that send and receive packets (e.g., network protocol packet 721₁ and network protocol packet 721₂).

Computing platform 706 may transmit and receive messages that can be composed of configuration data and/or any other forms of data and/or instructions organized into a data structure (e.g., communications packets). In some cases, the data structure includes program code instructions (e.g., application code) communicated through the Internet 748 and/or through any one or more instances of communications link 715. Received program code may be processed and/or executed by a CPU as it is received and/or program code may be stored in any volatile or non-volatile storage for later execution. Program code can be transmitted via an upload (e.g., an upload from an access device over the Internet 748 to computing platform 706). Further, program code and/or the results of executing program code can be delivered to a particular user via a download (e.g., a download from computing platform 706 over the Internet 748 to an access device).

Configuration 751 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to memory page swapping between a RAM device and a random access persistent memory device. In some embodiments, a module may include one or more state machines and/or combinational logic used to implement or facilitate the operational and/or performance characteristics pertaining to memory page swapping between a RAM device and a random access persistent memory device.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of memory page swapping between a RAM device and a random access persistent memory device). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to memory page swapping between a RAM device and a random access persistent memory device, and/or for improving the way data is manipulated when performing computerized operations pertaining to implementing swap techniques in an operating system kernel and/or in a device driver to facilitate memory paging operations to and from a memory mapped storage device.

Further details regarding general approaches to managing data repositories are described in U.S. Pat. No. 8,601,473 titled “ARCHITECTURE FOR MANAGING I/O AND SIORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING MAINTENANCE SERVICE FOR MANAGING I/O AND SIORAGE FOR A VIRTUALIZATION ENVIRONMENT”, issued on Oct. 1, 2013, which is hereby incorporated by reference in its entirety.

FIG. 7B depicts a virtualized controller implemented by containerized architecture 7B00. The containerized architecture comprises a collection of interconnected components suitable for implementing embodiments of the present disclosure and/or for use in the herein-described environments. Moreover, the shown containerized architecture 7B00 includes an executable container instance in configuration 752 that is further described as pertaining to the executable container instance 750. Configuration 752 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any executable container (e.g., executable container instance 750). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance (e.g., a Docker container instance) can serve as an instance of an application container. Any executable container of any sort can be rooted in a directory system, and can be configured to be accessed by file system commands (e.g., “ls” or “ls—a”, etc.). The executable container might optionally include operating system components 778, however such a separate set of operating system components need not be provided. As an alternative, an executable container can include runnable instance 758, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 776. Such a container virtual disk controller can perform any of the functions that the aforementioned CVM virtual disk controller 726 can perform, yet such a container virtual disk controller does not rely on a hypervisor or any particular operating system so as to perform its range of functions.

In some environments multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 7C depicts a virtualized controller implemented by a daemon-assisted containerized architecture 7C00. The containerized architecture comprises a collection of interconnected components suitable for implementing embodiments of the present disclosure and/or for use in the herein-described environments. Moreover, the shown instance of daemon-assisted containerized architecture 7C00 includes a user executable container instance in configuration 753 that is further described as pertaining to user executable container instance 780. Configuration 753 includes a daemon layer (as shown) that performs certain functions of an operating system.

User executable container instance 780 comprises any number of user containerized functions (e.g., user containerized function1, user containerized function2, . . . , user containerized functionN). Such user containerized functions can execute autonomously, or can be interfaced with or wrapped in a runnable object to create a runnable instance (e.g., runnable instance 758). In some cases, the shown operating system components 778 comprise portions of an operating system, which portions are interfaced with or included in the runnable instance and/or any user containerized functions. In this embodiment of a daemon-assisted containerized architecture, the computing platform 706 might or might not host operating system components other than operating system components 778. More specifically, the shown daemon might or might not host operating system components other than operating system components 778 of user executable container instance 780.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. A method comprising:
configuring a first swap device comprising a random access persistent memory (RAPM) device and a second swap device, wherein the first swap device is a byte-addressable device and the second swap device is a block-addressable device, the first swap device and the second swap device being different device types;
apportioning a swap address space of the RAPM device into one or more swap space areas;
assigning a swap space area from the one or more swap space areas to a virtualized entity operating in a computing system;
detecting a page swap event at the computing system; and
executing a paging operation based at least in part on the page swap event, the paging operation transferring a data page between a random access memory (RAM) device and the RAPM device.

2. The method of claim 1, further comprising recording the assigning of the swap space area in a virtual memory mapping data structure.

3. The method of claim 2, wherein the virtual memory mapping data structure is a page table.

4. The method of claim 1, wherein the apportioning of the swap address space corresponds to at least one of, a maximum virtualized entity quantity associated with the computing system, or a random access memory size.

5. The method of claim 1, further comprising transforming a block-addressable request into a byte-addressable request that is issued to the RAPM device to execute the paging operation.

6. The method of claim 1, further comprising issuing a virtual I/O request to the RAPM device to execute the paging operation.

7. The method of claim 1, wherein the data page is transferred between the RAM device and the RAPM device by executing a direct memory access page data transfer.

8. The method of claim 1, wherein a portion of the data page comprises a computer program instruction that is executed by an instruction processor.

9. The method of claim 1, wherein a portion of the data page comprises computer data that is read by an instruction processor during a DMA page data transfer.

10. The method of claim 9, wherein accessing the portion of the data page invokes a transfer of the data page from the RAPM device to the RAM device.

11. The method of claim 10, wherein a determination of whether or not a page in a swap area of the RAPM device should be brought into the RAM device corresponds to at least one of, a page table register, a lookaside table register, a statistical sampling, or a log.

12. The method of claim 1, wherein the RAPM device is accessed over a parallel bus or a serial bus.

13. A computer readable medium, embodied in a non-transitory computer readable medium, the non-transitory computer readable medium having stored thereon a sequence of instructions which, when stored in memory and executed by one or more processors causes the one or more processors to perform a set of acts, the set of acts comprising:
configuring a first swap device comprising a random access persistent memory (RAPM) device and a second swap device, wherein the first swap device is a byte-addressable device and the second swap device is a block-addressable device, the first swap device and the second swap device being different device types;
apportioning a swap address space of the RAPM device into one or more swap space areas;
assigning a swap space area from the one or more swap space areas to a virtualized entity operating in a computing system;
detecting a page swap event at the computing system; and
executing a paging operation based at least in part on the page swap event, the paging operation transferring a data page between a random access memory (RAM) device and the RAPM device.

14. The computer readable medium of claim 13, further comprising instructions which, when stored in memory and executed by the one or more processors causes the one or more processors to perform acts of recording the assigning of the swap space area in a virtual memory mapping data structure.

15. The computer readable medium of claim 14, wherein the virtual memory mapping data structure is a page table.

16. The computer readable medium of claim 13, wherein the apportioning of the swap address space corresponds to at least one of, a maximum virtualized entity quantity associated with the computing system, or a random access memory size.

17. The computer readable medium of claim 13, further comprising instructions which, when stored in memory and executed by the one or more processors causes the one or more processors to perform acts of transforming a block-addressable request into a byte-addressable request that is issued to the RAPM device to execute the paging operation.

18. The computer readable medium of claim 13, further comprising instructions which, when stored in memory and executed by the one or more processors causes the one or more processors to perform acts of issuing a virtual I/O request to the RAPM device to execute the paging operation.

19. A system comprising:
a non-transitory storage medium having stored thereon a sequence of instructions; and
one or more processors that execute the sequence of instructions to cause the one or more processors to perform a set of acts, the set of acts comprising,
configuring a first swap device comprising a random access persistent memory (RAPM) device and a second swap device, wherein the first swap device is a byte-addressable device and the second swap device is a block-addressable device, the first swap device and the second swap device being different device types;
apportioning a swap address space of the RAPM device into one or more swap space areas;
assigning a swap space area from the one or more swap space areas to a virtualized entity operating in a computing system;
detecting a page swap event at the computing system; and
executing a paging operation based at least in part on the page swap event, the paging operation transferring a data page between a random access memory (RAM) device and the RAPM device.

20. The system of claim 19, further comprising instructions which, when stored in memory and executed by the one or more processors causes the one or more processors to perform acts of recording the assigning of the swap space area in a virtual memory mapping data structure.
